(19) United States
(12) Patent Application Publication
(10) Pub. No.: US 2017/0021533 A1
(43) Pub. Date: Jan. 26, 2017

(54) Mold for casting concrete

(71) Applicant: Jian Qing WANG, Kowloon (HK)

(72) Inventor: Jian Qing WANG, Kowloon (HK)

(73) Assignee: Bestar Industrial HK Limited

(21) Appl. No.: 14/804,353

(22) Filed: Jul. 21, 2015

(51) Int. Cl. B29C 39/02

(52) U.S. Cl. CPC B29C 39/02; B29L 2031/00

(57) ABSTRACT

A mold for casting concrete contains: an inner part, an outer par, a temperature insulation layer, a fixing plate, and a pulling member. The inner part includes a cavity, an inlet, and an outlet which communicate with one another to flow first fluid into the cavity from the inlet and to discharge the first fluid out of the outlet from the cavity. The inner part further includes an outer fence and an inner fence on which the temperature insulation layer is arranged. The outer part is located outside the outer fence, between the outer part and the outer fence is defined a feeding chamber. The outer part includes a heating element and second fluid both defined therein, and the heating element is immersed in the second fluid. The fixing plate is mounted on the outer part and the inner part. The pulling member is fixed on the inner part.

### FIELD OF THE INVENTION

The present invention relates to a mold for casting concrete which removes a concrete product from the mold easily and quickly.

### BACKGROUND OF THE INVENTION

A conventional mold for casting concrete is made of wood or metal material and contains an inner part, an outer part, and a feeding chamber defined between the inner part and the outer part, such that concrete slurry is fed into the feeding chamber, and then the concrete slurry is hardened to form a concrete product.

However, the inner part and the outer part are removed from the convention mold difficultly.

The present invention has arisen to mitigate and/or obviate the afore-described disadvantages.

### SUMMARY OF THE INVENTION

The primary objective of the present invention is to provide a mold for casting concrete which removes a concrete product from the mold easily and quickly.

To obtain above-mentioned objective, a mold for casting concrete provided by the present invention contains: an inner part, an outer par, a temperature insulation layer, a fixing plate, and a pulling member.

The inner part is a hollow and includes a cavity, an inlet, and an outlet which all communicate with one another to flow first fluid into the cavity from the inlet and to discharge the first fluid out of the outlet from the cavity, the inner part further includes an inner fence and an outer fence opposite to the inner fence.

The temperature insulation layer is arranged on the inner fence of the inner part, the outer part is located outside the outer fence of the inner part, and between the outer part and the outer fence of the inner part is defined a feeding chamber, the outer part includes a casing in which a heating element and second fluid are defined, wherein the heating element is immersed in the second fluid.

The fixing plate is mounted on the outer part and the inner part.

The pulling member is fixed on the inner part.

### BRIEF DESCRIPTION OF THE DRAWINGS

FIG. 1 is a cross sectional view showing the assembly of a mold for casting concrete according to a preferred embodiment of the present invention.

FIG. 2 is a cross sectional view showing the exploded components of the mold for casting concrete according to the preferred embodiment of the present invention.

FIG. 3 is a cross sectional view showing the operation of the mold for casting concrete according to the preferred embodiment of the present invention.

### DETAILED DESCRIPTION OF THE PREFERRED EMBODIMENTS

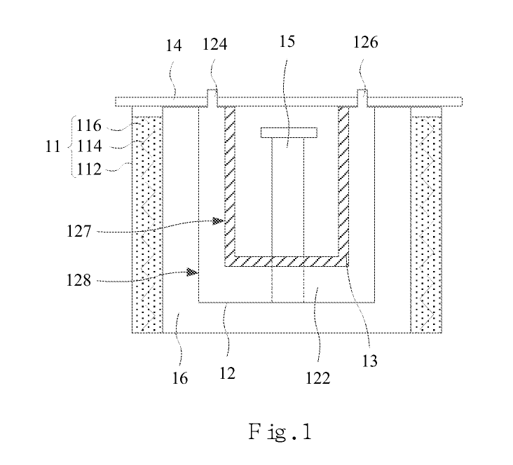

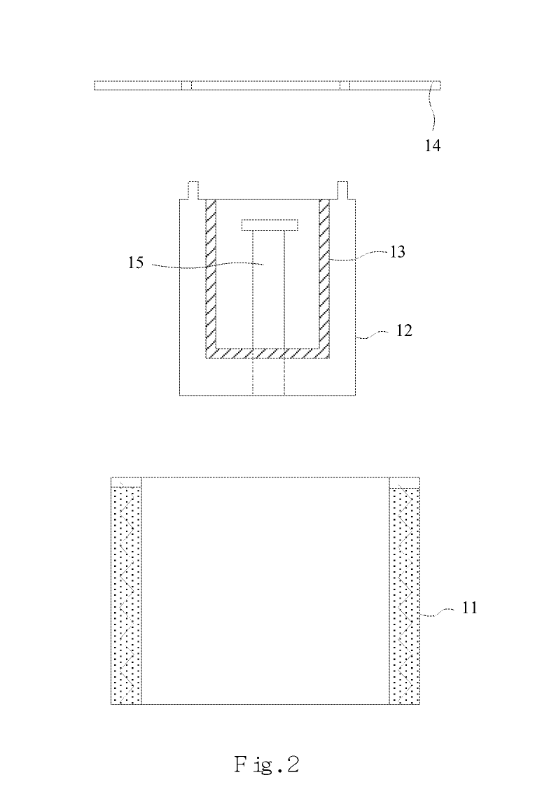

With reference to FIGS. 1 and 2, a mold 10 for casting concrete according to a preferred embodiment of the present invention comprises: an outer part 11, an inner part 12, a temperature insulation layer 13, a fixing plate 14, and a pulling member 15.

The inner part 12 is a hollow and includes a cavity 122, an inlet 124, and an outlet 126 which all communicate with one another to flow first fluid 18 into the cavity 122 from the inlet 124 and to discharge the first fluid 18 out of the outlet 126 from the cavity 122. The inner part 12 further includes an inner fence 127 and an outer fence 128 opposite to the inner fence 127.

The temperature insulation layer 13 is arranged on the inner fence 127 of the inner part 12. The outer part 11 is located outside the outer fence 128 of the inner part 12, and between the outer part 11 and the outer fence 128 of the inner part 12 is defined a feeding chamber 16. The outer part 11 includes a casing 112 in which a heating element 114 and second fluid 116 are defined, wherein the heating element 114 is immersed in the second fluid 116.

The fixing plate 14 is mounted on the outer part 11 and the inner part 12.

The pulling member 15 is fixed on the inner part 12.

The first fluid 18 is liquid or gas, and a temperature of the liquid or the gas is lower than a room temperature, wherein when the first fluid 18 is the liquid, the liquid is water or oil, such that when removing a concrete product 17 from the mold 10, the first fluid 18 cools the inner part 12, thus contracting the inner part 12. In addition, the inlet 124 and the outlet 126 are configured adjacent to the fixing plate 14.

The heating element 114 is a thermal resistance element, and the second fluid 116 is liquid which is water or oil, such that when removing the concrete product 17 from the mold 10, the heating element 114 heats the second fluid 116 to expand the outer part 11. Preferably, the heating element 114 is evenly arranged in the second fluid 116 to obtain brilliant heating effect. Furthermore, the second fluid 116 is not full of the casing 112 to avoid the second fluid 116 pressing the casing 112 in thermal expansion condition.

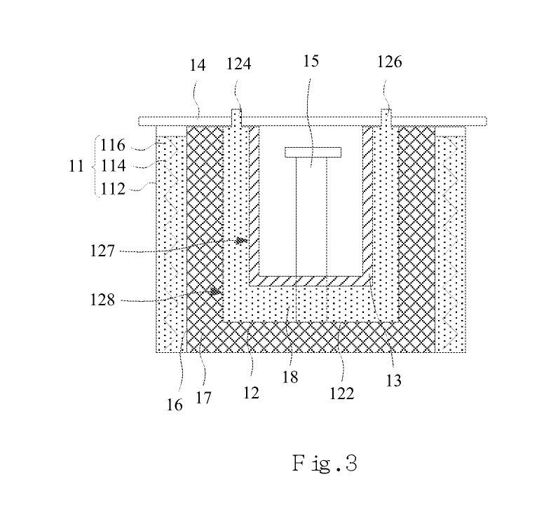

Referring to FIG. 3, in operation, concrete slurry is fed into the feeding chamber 16 so that the concrete slurry is hardened to manufacture the concrete product 17, and the first fluid 18 is fed into the cavity 122 from the inlet 124 (the temperature of the first fluid 18 is lower than the concrete product 17) to cool and contract the inner part 12, thus removing the concrete product 17 from the inner part 12. Then, electricity is supplied to the heating element 114 to heat the second fluid 116, such that the outer part 11 expends to remove from the concrete product 17. Thereafter, the inner part 12 is taken out by ways of the pulling member 15 and then the concrete product 17 is removed from the mold 10. It is to be noted that the first fluid 18 id discharged out of the outlet 126 from the inner part 12.

Thereby, the mold 10 expands and contracts by using the outer part 11 and the inner part 12, i.e., the outer part 11 is heated to expand, and the inner part 12 is cooled to contract, thus removing the concrete product 17 from the mold 10 easily and quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A mold for casting concrete comprising: an inner part, an outer par, a temperature insulation layer, a fixing plate, and a pulling member, wherein
the inner part is a hollow and includes a cavity, an inlet, and an outlet which all communicate with one another to flow first fluid into the cavity from the inlet and to discharge the first fluid out of the outlet from the cavity, the inner part further includes an inner fence and an outer fence opposite to the inner fence;
the temperature insulation layer is arranged on the inner fence of the inner part, the outer part is located outside the outer fence of the inner part, and between the outer part and the outer fence of the inner part is defined a feeding chamber, the outer part includes a casing in which a heating element and second fluid are defined, wherein the heating element is immersed in the second fluid;
the fixing plate is mounted on the outer part and the inner part;
the pulling member is fixed on the inner part.

2. The mold for casting concrete as claimed in claim 1, wherein the first fluid is liquid or gas, and a temperature of the liquid or the gas is lower than a room temperature.

3. The mold for casting concrete as claimed in claim 2, wherein the first fluid is water or oil.

4. The mold for casting concrete as claimed in claim 1, wherein the heating element is a thermal resistance element.

5. The mold for casting concrete as claimed in claim 1, wherein the second fluid is liquid.

6. The mold for casting concrete as claimed in claim 5, wherein the second fluid is water or oil.

7. The mold for casting concrete as claimed in claim 1, wherein the heating element is evenly arranged in the second fluid.

8. The mold for casting concrete as claimed in claim 1, wherein the inlet and the outlet are configured adjacent to the fixing plate.
